(19) United States
(12) Patent Application Publication
(10) Pub. No.: US 2003/0204644 A1
(43) Pub. Date: Oct. 30, 2003

(54) System and method for developing, deploying, and debugging software agents

(75) Inventor: Christopher R. Vincent, Arlington, MA (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, Armonk, NY (US)

(21) Appl. No.: 10/134,863

(22) Filed: Apr. 29, 2002

(51) Int. Cl. G06F 9/44; G06F 15/00

(52) U.S. Cl. 709/317; 715/513

(57) ABSTRACT

A method and system that allows definition of software agent packages that include software agent processing code and identification of zero or more processing extensions and of a runtime environment. In a preferred embodiment, an XML document is generated that identifies the files containing the agent code, identifies the runtime environment and extensions to be used by the agent, and that includes configuration data for the runtime environments and the extension modules. The agent software package includes descriptions of agent methods that are exposed through extensions and are available to external processes. The XML document and agent code form an agent package that is transmitted to an agent server for installation. The developer transmitting the agent package can optionally specify that an instance of the agent is to be started after installation.

### BACKGROUND OF THE INVENTION

1. Field of the Invention

The present invention relates to developing computer program modules, and more specifically to a system and method for developing, deploying and debugging software agents.

2. Description of Related Art

The software term “agent” is used to describe small, simple programs that act on behalf of a user, semi-autonomously, and/or work together to accomplish high-level goals. Examples of agents include small software programs that are developed in a scripting language, such as Javascript or Perl, or that are developed in more conventional computer programming languages such as C++, Java or FORTRAN. Agents are used to perform simple but fundamental tasks that aid individuals that use computers. Example tasks that are performed by software agents include the following.

1) A meeting scheduler that manages the process of arranging a meeting between a number of people with changing constraints.

2) A program that logs onto an instant messaging service to provide specialized services, such as directory lookup functions or message forwarding.

3) Workflow escalation agents that remind users when they need to attend to urgent business matters.

Software agents perform specialized tasks that often have many different applications. A software agent that performs one task may be useful to process data from multiple sources. A data transformation agent, for example, may be used to transform data retrieved either from a database or from an on-line data source that has a significantly different interface design than the database. Although the data transformation processing is the same, the processing to obtain input data and dispatch output data are different and implementation of the same transformation processing for data from these two data sources requires additional development. Requesting processing from a variety of sources and implementing the external interface processing for a variety of platforms and environments further increases the development burden for these agents. Modular software designs are used to reduce the development effort required to implement flexible agents that support a variety of interfaces by separating the data processing from the interface processing and reusing much of the interface processing modules for different data processing modules. The use of modular software, however, does not completely remove the requirement to modify the data processing design to accommodate different interfaces.

Business enterprises often simultaneously maintain software agents that are developed for a variety of environments or software platforms. For example, software agents developed to operate in environments or software platforms for Perl, Java 2 Enterprise Edition (J2EE), conventional computer languages and a large number of other development standards frequently coexist on an enterprise's computer system and must all be maintained. Each of these environments or software platforms typically have their own management environment and tools that do not interact with the management environments or tools of other environments or software platforms. These multiple environments or platforms often also implement their own security processing and other maintenance functions. The security processing available with the different environments or platforms may also not be equivalent and thus can result in different levels of security being available based upon the environment or platform used by the agent. Having the security processing distributed among several platforms or environments also requires additional effort to configure, and reconfigure, all of the platforms or environments to provide the security that is required.

Developing software agents for a variety of environments or platforms similarly requires various development platforms to support these different environments and/or platforms. Each of these platforms typically have a separate facility to install software agents so as to make new software agents available to other users. Each of these development platforms requires the establishment and maintenance of security configurations so that software agents are only able to be installed by authorized users. The authority to develop or modify software agents is often also limited to authorized users. Limiting the ability to install and develop software agents requires system administrators to develop and maintain security rules for each software agent development environment, which increases the effort required to support software agent development and increases the opportunity for human error in applying improper security restrictions to some of the development environments.

While an enterprise may require that all agents be developed under a single environment, this limits the ability of the enterprise to use existing agents that were developed under other environments. Restricting agents to a single environment also reduces the flexibility of agent designs that might be more efficiently developed under other environments.

### SUMMARY OF THE INVENTION

In view of these drawbacks, it is an object of the present invention to remove the above-mentioned drawbacks and to provide systems and methods for developing, deploying and debugging software agents.

One embodiment of the present invention provides a method for publishing a software agent. According to the method, a definition of an agent module is received, and a selection of a runtime module is received. An agent package is generated that includes the agent module and a runtime specification. The agent package is transmitted to an agent server for installation. In a preferred embodiment, a selection of at least one extension module is received, and the agent package also includes an extension specification for the extension module.

Another embodiment of the present invention provides a software agent publisher that includes an agent program definition tool, a runtime module selector, an agent package generator, and a transmitter. The agent program definition tool allows the definition of an agent program, and the runtime module selector receives a selection of a runtime module. The agent package generator generates an agent package that includes the agent module, a runtime specification and zero or more extension specifications. The transmitter transmits the agent package to an agent server for installation. In one preferred embodiment, the agent specification is an XML document.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a data diagram of an agent package in accordance with an exemplary embodiment of the present invention;

FIG. 2 is a schematic diagram of a software agent development and hosting environment in accordance with an exemplary embodiment of the present invention;

FIG. 3 is a processing flow diagram illustrating a software agent development processing flow in accordance with an exemplary embodiment of the present invention;

FIG. 4 is an agent definition interface in accordance with an exemplary embodiment of the present invention;

FIG. 5 is a web service exposure operator interface in accordance with an exemplary embodiment of the present invention;

FIG. 6 is an Add Method operator interface in accordance with an exemplary embodiment of the present invention;

FIG. 7 illustrates a runtime module specification XML document in accordance with an exemplary embodiment of the present invention;

FIG. 8 illustrates an extension module specification XML document in accordance with an exemplary embodiment of the present invention;

FIG. 9 illustrates an agent specification XML document in accordance with an exemplary embodiment of the present invention; and

FIG. 10 is a processing flow diagram illustrating a command line interface processing flow in accordance with an exemplary embodiment of the present invention.

### DETAILED DESCRIPTION OF PREFERRED EMBODIMENTS

Preferred embodiments of the present invention will be described in detail hereinbelow with reference to the attached drawings.

The exemplary embodiments of the present invention facilitate development, configuration, publishing (i.e., deploying) and debugging of software agents that are able to be developed and hosted on a variety of environments and platforms. Agents developed by the exemplary embodiments of the present invention are defined by agent packages that are communicated to and installed on a central agent server. An agent package 100, according to an exemplary embodiment of the present invention, is shown in FIG. 1. Agents used by the exemplary embodiments of the present invention are implemented with a modular design that contains an agent module 102, a runtime specification 104 and an extension specification 106.

The agent module 102 of the exemplary embodiment contains the program instructions for performing the action associated with that agent. The agent module 102 of various embodiments contains either source code or program data in another format to define the processing performed by the particular agent. The agent module contains software to perform a task and is designed to execute in a particular runtime environment. The runtime specification 104 of the exemplary agent package 100 specifies the runtime environment in which the agent module 102 is to execute. Examples of the runtime specification 104 include a Javascript runtime environment, a Perl runtime environment or any other runtime environment required by the particular agent module 102.

Agent package 100 also contains zero or more extension specifications that identify and specify extensions that the agent module 102 is able to use. Extensions within the exemplary embodiments of the present invention are software modules that provide expanded functionality to software agents. Examples of extensions include software modules that perform processing to implement interfaces between the processing of the agent module 102 and external software processes such as databases, instant messaging services and other so-called “middleware” applications. The extension specification 106 is also able to specify no extensions to indicate that the agent module does not utilize extensions. Alternative embodiments are able to make the extension specification 106 optional within agent package 102. A list of extensions is also able to be provided as is described below.

The agent package 100 of the exemplary embodiment does not contain the executable software for the runtime or extension modules. The executable software for these modules is installed on the agent server that hosts the agent and the specifications of these modules in the agent package 100 merely serve to identify which of these modules is to be used by the hosting agent server when creating an instance of this agent. These specifications are also able to contain configuration data for the runtime module or the zero or more extensions in order to ensure proper configuration of these modules when used to support the agent.

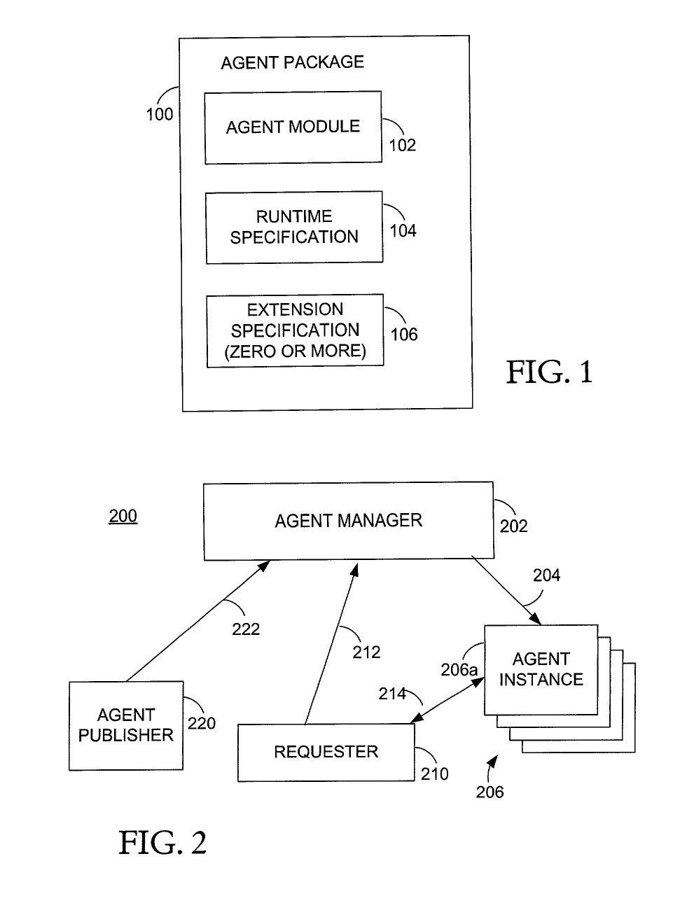

A software agent hosting environment 200 according to an exemplary embodiment of the present invention is shown in FIG. 2. The software agent hosting environment has an agent manager 202 that performs as an agent hosting server and manages and controls the execution of the software agents in this exemplary embodiment. The software agents utilized by this exemplary embodiment are able to be developed in or for a large variety of environments or platforms. Agents are able to be developed in high level languages such as Javascript, Perl, C++, Java or FORTRAN, or in any other environment. The agent packages 100 in the exemplary embodiment are developed and maintained via tools provided in the agent publisher 220, which is described in more detail below. The agent publisher 220 allows an agent developer to create an agent module 102 and define the runtime specification 104 and an extension specification 106 if required. The agent publisher further contains tools to modify existing agent packages 100.

Once the agent package 100 is defined via the agent publisher 220, the newly created or modified agent package 100 is then communicated to the agent manager 202 over communications link 222 for installation into the agent manager 202. Communications link 222 of the exemplary embodiment allows the agent publisher 220 or another process to remotely install, query and manage the agents installed within the agent manager 202. The exemplary embodiment utilizes web services based upon the Simplified Object Access Protocol (SOAP) and Java Remote Method Invocation (RMI) to perform these tasks. Alternative embodiments use other protocols and communications means to implement the tasks of installing, querying and managing the installed agents.

Agent manager 202 accepts, over request link 212, service requests from a requester 210 that are to be performed by a software agent installed within the agent manager 202. The agent manager 202 of the exemplary embodiment is able to interact with a large number of requesters that are of many types. A requester 210 is able to be an individual user of a computer using a software application such as a specialized software application or an HTTP-based web browser. A requester 210 is also able to be a computer program or process that is configured to request software agent services through the agent manager 202.

Once the agent manager 202 of the exemplary embodiment receives a service request from a requester 210, the agent manager 202 creates an instance 206a of the required agent. The agent manager 202 of the exemplary embodiment is able to create and manage a large number of executing agent instances 206, of which a particular agent instance 206a is used to satisfy a particular service request. In order to satisfy the service request, the agent instance 206a in this example is configured to operate with the required extensions. The agent manager in this embodiment configures the agent instance 206a to operate with the extensions that were specified by the agent developer when the agent package was defined via the tools of the agent publisher 220. For example, the exemplary embodiment utilizes extensions to allow an agent module 102 to communicate with data sources such as SQL database managers, workplace collaboration software such as Lotus Domino (available from International Business Machines Corporation) and other data sources. Agent modules are also able to communicate with individuals or other processes via various communications means such as internet communications and instant messaging (including instant messaging provided by the Lotus Sametime software product available from International Business Machines Corporation). Extensions are able to be developed that implement interfaces to a wide variety of software processing components and computer processing services that are either hosted on the same computing system or that are hosted remotely from the executing agent module 102.

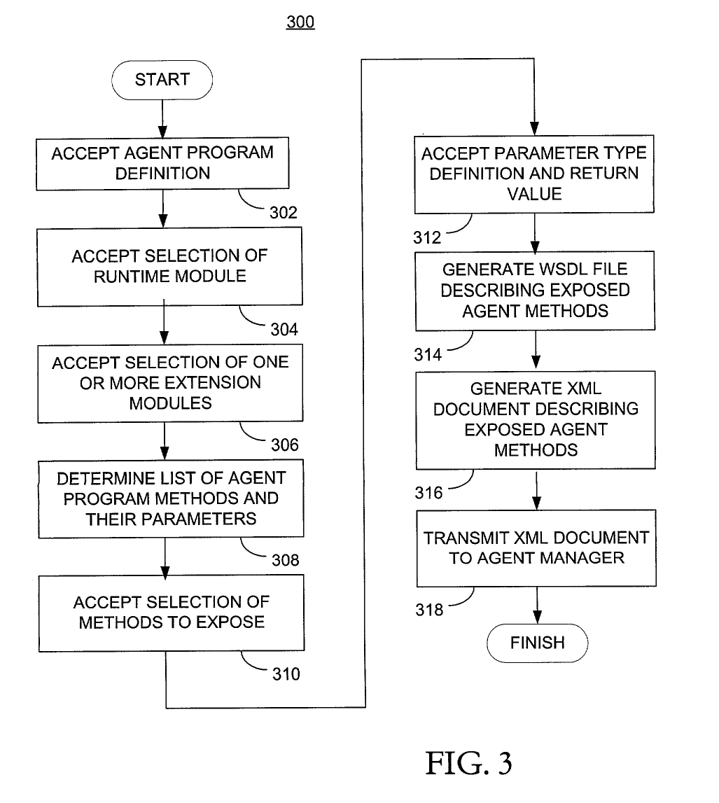

An exemplary software agent development processing flow 300 that is performed by the agent publisher 220 to create a software agent package 100 is illustrated in FIG. 3. The software agent development processing flow 300 described below is one exemplary logical flow that is able to be followed by a software agent developer when performing a straightforward software agent development process. The development of a software agent package 100 in the exemplary embodiment is able to be an iterative process in which the steps described in this example flow are able to be repeated or performed in a different order than that described below. It is to be understood that the flexibility of the agent publisher 220 of the exemplary embodiment allows performance of the illustrated steps in a different order than that described below without deviating from the scope of the present invention.

The development of the software agent package 100 begins, at step 302, by accepting a definition of the agent program. The agent program in the exemplary embodiment is the source code that defines the agent module 102. The agent modules 102 of the exemplary embodiment are able to be defined in a variety of programming languages including C++, Java, Javascript and others. The step of accepting the agent program definition is performed by the exemplary embodiment by providing text editing capabilities to the software developer and allowing the developer to enter the agent program source code, as is further described below. Alternative embodiments provide a linkage to other software development environments that facilitate development and debugging of the agent module programming code.

After the agent program definition has been accepted, the exemplary software agent processing 300 then accepts, at step 304, a selection of a runtime module. The runtime module is selected in the exemplary embodiment via an operator interface, as is described below. After the runtime module is selected, the exemplary processing then accepts, at step 306, a selection of one or more extension modules that are able to operate with the agent package being developed. An agent package does not require a specification of extensions but one or more extensions are able to be specified.

The exemplary processing then determines, at step 308, a list of agent program methods (i.e., functions) and the parameters of these methods. The exemplary embodiment examines the agent processing software within the agent module 102 to determine the functions that are contained within the agent module and the parameters of those functions. The exemplary embodiment of the present invention then displays these functions, in a Graphical User Interface, as methods that are able to be exposed to external processes or users, as is described below. After the methods are determined, the processing then accepts, at step 310, selections of one or more of those functions as the methods that are to be exposed. After selection of one or more methods, the exemplary processing then accepts, at step 312, a definition of the parameter types and return value for the selected methods.

After the methods and the parameter types for the methods' parameters and return values are selected, the exemplary processing then generates, at step 314, a Web Service Definition Language (WSDL) file to describe the exposed method or methods that are to be available through a Web Services extension. The WSDL file is generated for the benefit of web service clients by describing available operations so that other programs/developers are able to interact with the agent. The processing of the exemplary embodiment then generates, at step 316, an XML document describing the exposed agent methods and transmits, at step 318, this document to an agent manager 202. The Agent Publisher 220 of the exemplary embodiment allows the developer to specify whether or not an instance of the new agent is to be immediately started after it is installed. If an instance is to be started, that information is also transmitted to the agent manager 202.

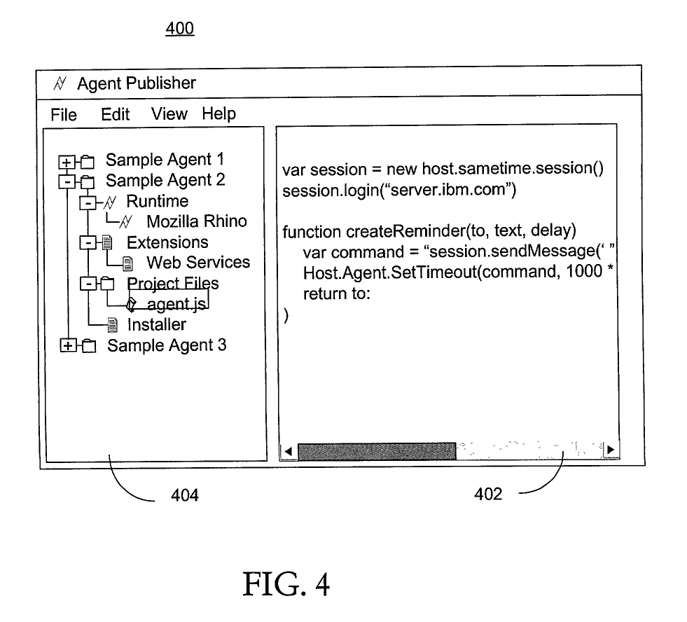

Software agent packages 100 are created in the exemplary embodiment by tools provided within the agent publisher 220. An exemplary agent definition interface 400 for the exemplary agent publisher 220 is illustrated in FIG. 4. The agent definition interface 400 includes a text editing window 402 that is the agent program definition means of this embodiment. It allows an agent developer to enter source code that defines the processing of the software agent.

The agent definition interface 400 further includes a module definition window 404. The module definition window 404 is the extension module selector and runtime module selector that allows selection of extension modules and runtime modules that are to be included in a software agent package 100. The exemplary agent definition interface 400 includes a module definition window 404 that illustratively shows three Sample Agents: Sample Agent 1, Sample Agent 2, and Sample Agent 3. The exemplary module definition window 404 presents agent package components in a tree-like structure that allows details and contents of the agent package and its constituent modules to be shown or hidden. The exemplary module definition window 404 as shown is hiding the details of Sample Agent 1 and Sample Agent 3 to facilitate the developer's examination of Sample Agent 2. The details of Sample Agent 2 are shown and include a Runtime Module, Extension Module and Project Files entries.

The Project Files entry within the module definition window 404 provides the processing definition contained within the agent module 102. The software that makes up the agent module 102 in this simple example is the source code shown in the text editing window 402. The facilities of the text editing window 402 in this exemplary embodiment are an agent program definition tool that allow the developer to enter and edit the text that makes up the source code for the agent module 102. The exemplary agent publisher 220 also allows multiple files to be used to hold the software that defines the agent processing. The exemplary illustration shows one project file, agent.js, that contains Javascript code that defines the agent processing. Sub-entries, such as a specific project files, are added to entries, such as the Project Files category, via the facilities of the Graphical User Interface (GUI) presenting the agent definition interface, as is conventionally known. An example of adding a specific program file to the Program Files entry is to “right click” on the Project Files entry by placing a pointer of the GUI interface over the Program Files entry and pressing the right mouse button. This action will cause a list of files to be presented to the developer, who is then able to select a file for addition as a sub-entry to the Program Files entry. Right clicking on a sub-element in the exemplary embodiment further provides an option to remove that sub-element.

The exemplary agent definition interface 400 further contains pull-down menu items File, Edit, View and Help. The File pull-down menu includes an option to generate the agent package 100. This performs the processing of the agent package generator. The agent package transmitter is similarly invoked from the File pull-down menu option that opens a dialog box that allows specification of the agent server to which to transmit, or deploy, the agent, as well as an option to cause an instance of the agent to be started after installation.

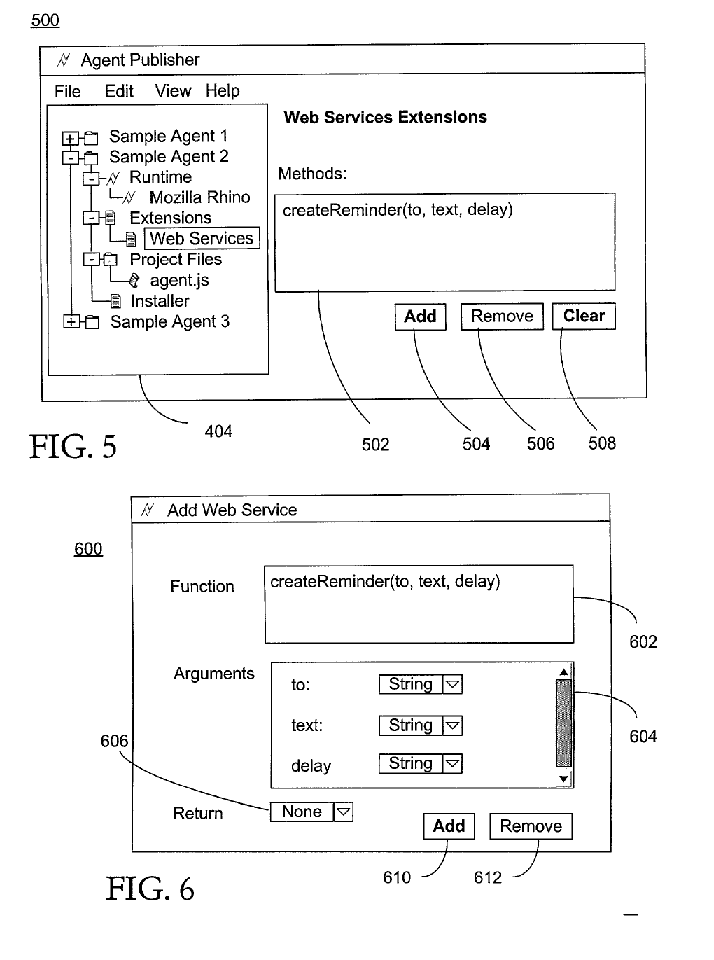

The developer of a software agent is able to select object methods, such as processing procedures or functions contained within the agent module software, to expose as web services. Web services in this context are methods that are able to be invoked by remote processes or users. An exemplary web service exposure operator interface 500 is illustrated in FIG. 5. The exemplary method exposure operator interface 500 is displayed in response to a developer selecting a particular extension module in the module definition window 404 from any operator interface display that includes a module definition window 404. The exemplary method exposure operator interface 500 contains a module definition window 404, a selected methods window 502, and three control buttons: the Add button 504, the Remove button 506 and the Clear button 508.

The module definition window 404 allows selection of the extension through which a method is to be exposed. Extension modules and runtime modules are also able to be added or removed through the module definition window via the facilities of the GUI as is described above for Program Files. Adding or removing runtime modules from the runtime entry of the module definition window 404 performs the function of the runtime module selector in the exemplary embodiment. In the exemplary configuration that includes a general Web Services extension, a method that is exposed through the Web Services extension is available to other network users. Other extensions are able to be more specific, such as a specialized Instant Messaging extension. In the case of a specialized Instant Messaging extension, an exposed method is only able to be accessed by or is only able to have access to an external instant messaging system to receive or send messages.

The selected methods window 502 of the exemplary method exposure operator interface 500 displays methods of the agent that will be exposed (i.e., available to processes and users external to the agent) through the extension that is selected in the module definition window 404. The selected methods window 502 displays those methods that have already been selected for exposure outside of the agent. An agent developer is able to select new methods to expose to external processes and/or users by clicking on the Add button 504, as is described below. A developer using the exemplary agent publisher 220 is also able to remove a method from the selected methods window 502, and thereby cause the method to no longer be exposed, by selecting the method (via the Graphical User Interface (GUI) facilities of the computer on which the exemplary agent publisher 220 is executing) and selecting (e.g., clicking on) the Remove button 506. The developer is also able to remove all methods from the selected methods window 502 by selecting the Clear button 508.

When a developer selects the Add button 504 in the exemplary agent publisher 220, the Agent Publisher 220 determines all functions within the agent module that are able to be exposed and an Add Method operator interface 600 is displayed. An exemplary Add Method Operator Interface 600 is illustrated in FIG. 6. The exemplary Add Method operator interface 600 has a Function list 602 that contains a list of functions that are able to be exposed via the extension that was selected in the method exposure operator interface 500. The exemplary embodiment allows all functions contained within the Project Files for the agent, as defined within the module definition window 404, to be exposed as methods via an extension. Alternative embodiments are able to restrict the types of functions or procedures that are able to be exposed as methods.

The Add Method Operator Interface 600 further contains an Argument Definition window 604. The Argument Definition window 604 is used for software languages, such as Javascript, that do not explicitly define data types for function arguments or return values. Proper operation of exposed methods often requires definition of the data types of arguments and the value returned by an exposed method. The Argument Definition window 604 of the exemplary embodiment contains one line for each input parameter (i.e., argument) of the selected function within the Function list 602 that identifies the input parameter and that also has a pull-down box defining the data type of that parameter (e.g., the String data type). The Return Value data type selection box 606 similarly allows the developer to specify the data type of the value returned by the selected function within the Function list 602.

Once the developer has selected the data types for the parameters and return values of the selected method within the Functions list 602, these values are accepted and the function is added by selecting the Add button 610. The function that is selected within the Function list 602 is also able to be removed (i.e., undo the previously performed selection and parameter type definition processing) from the selected methods window 502 by selecting the Remove button 612.

As an alternative to exposing methods via the operator interfaces described above, alternative embodiments of the present invention support exposing methods as web services through programming contained within the agent code itself.

The software agent publisher 220 of the exemplary embodiment accepts and generates XML document files that specify the objects and relationships between the objects contained within the Agent Package 100. The Agent Publisher 220 of the exemplary embodiment accept XML documents that describe Runtime modules and that also describe the extensions that are available on agent servers and that are able to be used by a developed agent module 100. The Agent Publisher 220 of the exemplary embodiment generates an XML document that describes the agent package itself.

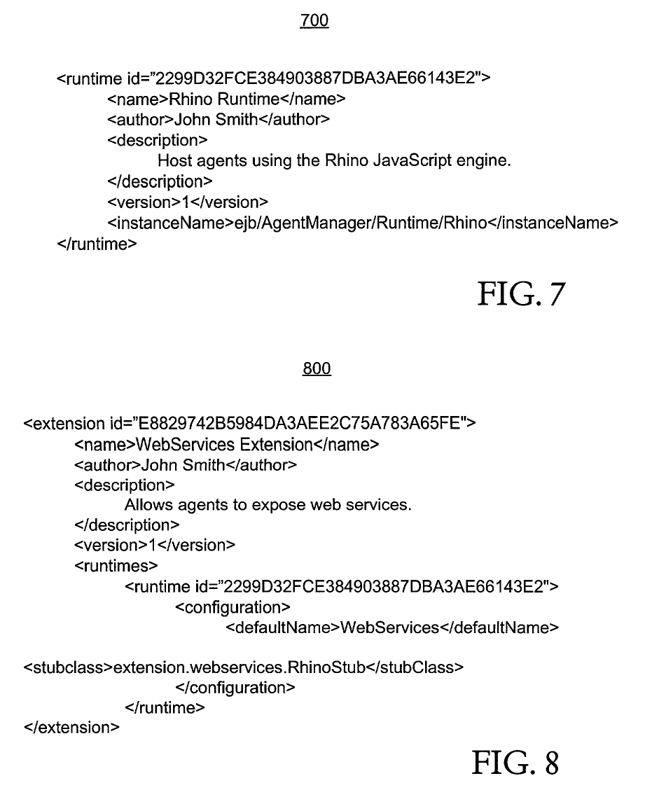

A runtime module XML specification 700 that is accepted by an exemplary embodiment of the present invention is illustrated in FIG. 7. The exemplary runtime XML specification 700 defines a runtime module object that is able to be used by an agent that is being developed. The exemplary runtime XML specification 700 is provided as an input to the agent publisher. The exemplary runtime module XML specification 700 is shown to have a runtime id that contains an alphanumeric string that is a unique identification of the particular Runtime specification. The runtime id in the exemplary embodiment of the present invention is established when the runtime is created by the runtime developer. The exemplary runtime specification 700 of the exemplary embodiment also contains an author, description and version field that describe these characteristics for this particular runtime module. The exemplary runtime specification 700 also contains a field describing the instanceName that provides identification data for the executable object of the described runtime module. In an example using a J2EE application, the instance name is the data provided by the Java Naming and Directory Interface (JNDI) for the entity bean home that is associated with the runtime's agent instance implementation.

An exemplary extension module XML specification 800 that is accepted by an exemplary embodiment of the present invention is illustrated in FIG. 8. The exemplary extension module XML specification 800 defines the Extensions that are able to be used by the developed agent. The exemplary extension specification 800 is shown to have an extension id that contains an alphanumeric string that is a unique identification of the particular Extension object. The extension id in the exemplary embodiment of the present invention is established when the extension is created by its developer. The exemplary extension module XML specification 800 of the exemplary embodiment also contains a name, author, description and version field that describes these characteristics for the particular extension. The exemplary extension specification 800 includes a runtimes specification field that identifies the runtime objects with which the Extension object is able to operate along with a specification of the configuration of that runtime that is required for proper operation of this extension.

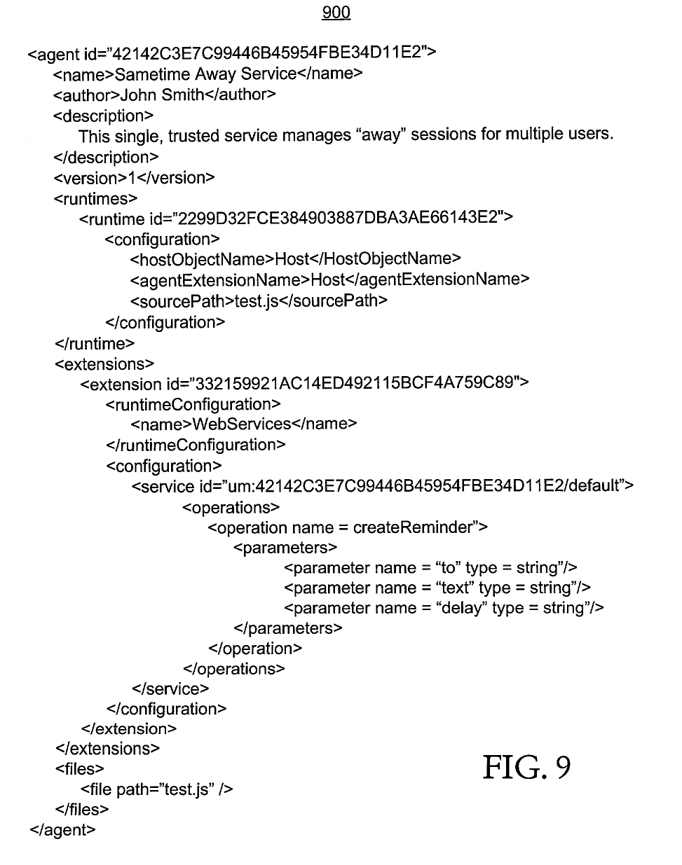

An exemplary agent specification 900 as is generated by the Agent Publisher 220 of an exemplary embodiment is illustrated in FIG. 9. The exemplary agent specification 900 defines the data for the component specifications included within the agent package 100 for an agent. The exemplary agent specification 900 is shown to have an agent id that contains an alphanumeric string that is a unique identification of the particular agent object 302. The agent id in the exemplary embodiment of the present invention is established when the agent is initially created by the development system, such as when a developer selects the “new agent” option in the development system. The agent specification 900 of the exemplary embodiment also contains a name, author, description and version field that are configured within the agent publisher 220, and the agent publisher of the exemplary embodiment inserts this data into the XML document upon creation of the agent specification 900. The exemplary agent specification 900 includes a runtime specification field that identifies the runtime object with which the agent package 100 is able to operate along with a specification of the configuration of that runtime. The exemplary agent specification 900 also includes an extension specification field that identifies the extensions with which the agent package 100 is able to operate along with a specification of the configuration of that extension. The web services extension configuration definition includes a specification of the exposed method. The exemplary agent specification 900 also includes a files field that contains a specification of the file that contains the software that defines the processing for this agent.

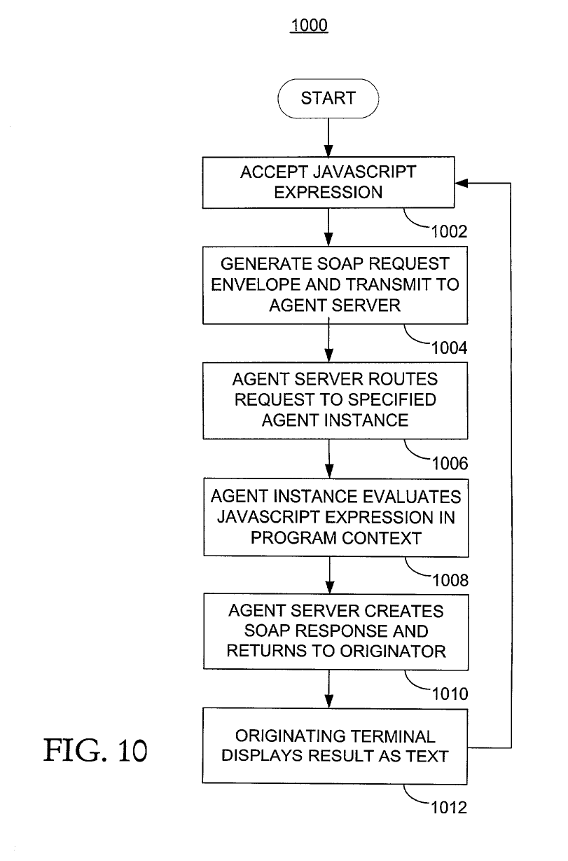

The facilities of the agent manager 202 allow command line Javascript expressions to be entered at a remote computer and evaluated by an executing software agent within that agent's program context. This facilitates debugging executing agents, especially after the agent package 100 is communicated to an agent manager and installed, without having to use a dedicated debugger. The ability to remotely enter Javascript expressions for evaluation by an executing agent allows a developer to easily determine the state of an executing agent and determine the agent's behavior. This allows monitoring and modification of an agent instance without disrupting the availability of the agent's service. A command line interface processing flow 1000 for an exemplary remote debugger is illustrated in FIG. 10. The processing begins by accepting, at step 1002, a Javascript expression on a remote computer. The remote computer then generates, at step 1004, a Simple Object Access Protocol (SOAP) request envelope containing the Javascript expression that was accepted. The processing then calls the evaluateText web service method of the agent manager 202. The agent manager 202 then routes, at step 1006, the request to the specified agent instance for evaluation of the entered Javascript expression in its program context. The agent instance then evaluates, at step 1008, the Javascript expression in its program context and returns the result to the agent manager 202. The agent manager 202 then creates, at step 1010, a SOAP response envelope containing the response and returns this envelope to the process that generated the SOAP request. The operator interface then displays, at step 1012, the result in a text window. The processing then resumes by accepting, at step 1002, another Javascript expression.

The exemplary embodiments of the present invention support agent development in a variety of development environments while supporting a uniform software agent hosting environment for installing, maintaining and managing the use of software agents

in a heterogeneous computer environment. The exemplary embodiments advantageously provide a database structure to link software agent executables to their runtime environments and a database of associated processing extensions.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when loaded and executed, controls the computer system such that it carries out the methods described herein.

The present invention can also be embedded in a computer program product, which comprises all the features enabling the implementation of the methods described herein, and which—when loaded in a computer system—is able to carry out these methods. In the present context, a “computer program” includes any expression, in any language, code or notation, of a set of instructions intended to cause a system having an information processing capability to perform a particular function either directly or after either or both of the following: a) conversion to another language, code, or notation; and b) reproduction in a different material form.

Each computer system may include one or more computers and a computer readable medium that allows the computer to read data, instructions, messages, or message packets, and other computer readable information from the computer readable medium. The computer readable medium may include non-volatile memory such as ROM, Flash memory, a hard or floppy disk, a CD-ROM, or other permanent storage. Additionally, a computer readable medium may include volatile storage such as RAM, buffers, cache memory, and network circuits. Furthermore, the computer readable medium may include computer readable information in a transitory state medium such as a network link and/or a network interface (including a wired network or a wireless network) that allow a computer to read such computer readable information.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for publishing a software agent, the method comprising:
receiving a definition of an agent module;
receiving a selection of a runtime module, the agent module being configured to operate with the runtime module;
generating an agent package that includes the agent module and a runtime specification, the runtime specification describing the runtime module; and
transmitting the agent package to an agent server for installation.

2. The method as defined in claim 1, further comprising the step of:
receiving a selection of at least one extension module,
wherein the agent package also includes an extension specification for the at least one extension module.

3. The method as defined in claim 2, further comprising the step of receiving a selection of at least one function within the agent module that is to be made available to external processes.

4. The method as defined in claim 3, further comprising the step of defining an external software interface that is available through the at least one extension module, the external software interface using the function selected to be made available to external processes.

5. The method as defined in claim 3, further comprising the step of receiving a definition of a data type for at least one parameter or an output of the function selected to be made available to external processes.

6. The method as defined in claim 2, wherein at least one of the runtime module and the extension module is a pre-existing module.

7. The method as defined in claim 1, further comprising the step of directing the agent server to start the agent module.

8. The method as defined in claim 1, wherein the agent specification is an XML document.

9. A software agent publisher comprising:
an agent program definition tool for allowing the definition of an agent program;
a runtime module selector for receiving a selection of a runtime module, the agent module being configured to operate with the runtime module;
an agent package generator for generating an agent package that includes the agent module and a runtime specification, the runtime specification describing the runtime module; and
a transmitter for transmitting the agent package to an agent server for installation.

10. The software agent publisher as defined in claim 9, further comprising an extension module selector for receiving a selection of at least one extension module,
wherein the agent package also includes an extension specification of the at least one extension module.

11. The software agent publisher as defined in claim 10, wherein the agent module definition tool receives a selection of at least one function within the agent module that is to be made available to external processes.

12. The software agent publisher as defined in claim 11, wherein the extension module selector receives a definition of an external software interface that is available through the at least one extension module, the external software interface using the function selected to be made available to external processes.

13. The software agent publisher as defined in claim 11, wherein the extension module selector receives a definition of a data type for at least one parameter or an output of the function selected to be made available to external processes.

14. The software agent publisher as defined in claim 9, wherein the transmitter directs the agent server to start the agent module.

15. The software agent publisher as defined in claim 9, wherein the agent specification is an XML document.

16. A machine-readable medium encoded with a program for publishing a software agent, the program including instructions for:
receiving a definition of an agent module;
receiving a selection of a runtime module, the agent module being configured to operate with the runtime module;
generating an agent package that includes the agent module and a runtime specification, the runtime specification describing the runtime module; and
transmitting the agent package to an agent server for installation.

17. The machine-readable medium as defined in claim 16, wherein the program further includes instructions for:
receiving a selection of at least one extension module,
wherein the agent package also includes an extension specification for the at least one extension module.

18. The machine-readable medium as defined in claim 17, wherein the program further includes instructions for receiving a selection of at least one function within the agent module that is to be made available to external processes.

19. The machine-readable medium as defined in claim 18, wherein the program further includes instructions for defining an external software interface that is available through the at least one extension module, the external software interface using the function selected to be made available to external processes.

20. The machine-readable medium as defined in claim 18, wherein the program further includes instructions for receiving a definition of a data type for at least one parameter or an output of the function selected to be made available to external processes.

21. The machine-readable medium as defined in claim 16, wherein the program further includes instructions for directing the agent server to start the agent module.

22. The machine-readable medium as defined in claim 16, wherein the agent specification is an XML document.
